(19) United States
(12) Patent Application Publication
(10) Pub. No.: US 2002/0032538 A1
(43) Pub. Date: Mar. 14, 2002

(54) Software test system and method

(76) Inventor: Young-seok Lee, Seoul (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/851,405

(22) Filed: May 8, 2001

(30) Foreign Application Priority Data
May 9, 2000 (KR) 00-24608
Sep. 1, 2000 (KR) 00-51651

(51) Int. Cl. G06F 19/00

(52) U.S. Cl. 702/119

(57) ABSTRACT

A software test system and a method therefor include a function library file for functionizing commands for executing the objects of the software after converting the commands to functions. An object file sequentially records keywords, each of which indicates an object of the software, in an order in which it is desired to test the software. Each keyword is distinguished by an object identifier. An execution program sequentially reads keywords from the object file, recognizes an object to execute, calls a function for executing the recognized object from the function library file, and executes the function. According to the software test system and method, maintenance due to changes in target software is very simply carried out, and the software test system and method can be easily applied to other software and product tests by only re-defining some functions.

### CLAIM FOR BENEFIT OF PRIORITY UNDER 35 U.S.C. §119

The present application claims the benefit of priority under 35 U.S.C. §119 to Korean Patent Application No. 00-24608 filed on May 9, 2000 and to Korean Patent Application No. 00-51651 filed on Sep. 1, 2000.

### BACKGROUND OF THE INVENTION

1. Field of the invention

The present invention relates to a software test, and more particularly, to a software test system, of which maintenance is convenient, and a method therefor.

2. Description of the Related Art

Generally, a test tool, which automatically tests target software to be tested, in a recording method, generates a great many script files. Particularly, when it comes to a test tool using a linear script technology, such as TeamTest from Rational Software Corporation, script files are generated with respect to the number of test cases. For example, if target software is to be tested using TeamTest, a user first makes a test scenario, and then, with TeamTest operating, executes target software once according to the test scenario. TeamTest generates corresponding script files every time target software is executed according to the test scenario, and tests target software by automatically executing target software with generated script files.

FIG. 1 illustrates generation of scripts when target software is automatically tested using TeamTest.

As shown in FIG. 1, a test tool using a linear script technology, such as TeamTest, generates scripts 3A1 through 3An, by executing target software once according to a test scenario 1. TeamTest automatically tests target software according to the generated scripts 3A1 through 3An.

FIG. 2 illustrates an example of scripts 3A1 through 3An generated by the automatic test tool shown in FIG. 1. As shown in FIG. 2, n scripts are provided for as many as the number of test cases are generated, and a command (for example, “Window SetContext”, “MenuSelect”, or “PushButton”) and data (for example, “No Title-Notepad”, “Open”, or “Cancel”) are mixed in each of the scripts.

Meanwhile, the software test using a linear script technology as this should again generate a script file, by modifying or partially re-executing scripts 7 (FIG. 1), which correspond to the changed part of target software, when target software changes. If it is difficult to modify corresponding script files, or it is impossible to partially re-generate new script files, all the generated scripts 3A1 through 3An should be discarded and script files according to the test scenario should be generated again from the beginning. This time for discarding existing script files and generating new script files can be measured by the following equation 1:

Script regenerating time=the screen changing ratio of target software×average time for generating a script×the total number of scripts×coefficient (R) (1)

Here, the coefficient (R) should be determined considering the size of a project, the script size, the total number of scripts, and the number of functions, but the coefficient (R) is set to ‘1’, here. If the total number of scripts is limited to 50, the screen changing ratio of target software is 5%, and the time for generating a unit script is 0.3 hour, then the time for regenerating scripts is 0.75 hours. If 50% of the entire screen changes though the changing size of target software is small, that is, if the screen changing ratio is 50%, then the time for regenerating scripts is 7.5 hours. In conclusion, the maintenance of the software test tool is complicated and needs much time according to the change of the target software.

Linear script technology is generally used to test target software. However, as described above, the corresponding scripts in the script files need to be modified or regenerated when using the linear script technology even where the target software undergoes a minor change. In worst cases, all scripts need to be regenerated. Also, since script files are generated with respect to the number of test cases of target software, the more test cases there are, the more difficult it becomes to maintain and repair script files.

In conclusion, where the target software is tested using the conventional linear script technology, the greater the number of test cases and more frequent the changes to the target software, the greater the time and efforts required to test the software.

### SUMMARY OF THE INVENTION

To solve the foregoing problems, present invention provide a software test system in which maintenance for changes in software to be tested is simple.

One aspect of the present invention is to provide a test method performed in the software test system.

Another aspect of the present invention is to provide a computer readable recording medium which stores a program for executing the software test method.

To accomplish the above aspect of the present invention, a software test system is provided for testing software which is executed in a computer. The software test system has a function library file for functionizing commands to execute the objects of the software after converting the commands to functions. An object file sequentially records keywords, each of which indicates an object of the software, in an order in which it is desired to test the software. Each of the keywords is distinguished by an object identifier. An execution program sequentially reads keywords from the object file, recognizes an object desired to execute, calls a function from the function library file for executing the recognized object, and executes the function.

To accomplish another aspect of the present invention, a software test system is also provided for testing software which is executed in a computer. The software test system has a function library file for functionizing commands for executing the objects of the software after converting the commands to functions. An object management unit stores keywords corresponding to respective objects of the software and stores factor values needed for executing the functions. The keywords and factor values are sequentially input in an order in which it is desired to test the software. An execution program sequentially reads the keywords and factor values from the object management unit, calls functions for executing objects corresponding to the keywords, and executes the called functions using factor values.

To accomplish another aspect of the present invention, a software test system is also provided for testing software which is executed in a computer. The software test system has a function library file for functionizing commands for executing the objects of the software after the commands are converted to functions. A script analyzing unit extracts keywords and factor values in an order in which it is desired to test the software is tested. The keywords and factor values are extracted from the scripts generated when a first test is performed. An object management unit stores keywords corresponding to respective objects of the software and stores factor values needed for executing the functions. The keywords and the factor values are sequentially input after being extracted in the script analyzing unit. An execution program sequentially reads the keywords and factor values from the object management unit, calls functions for executing objects corresponding to the keywords, and executes the called functions using factor values.

To accomplish another aspect of the present invention, a software test method is provided for testing target software in a software test system which is executed in a computer. The software test system has a function library file obtained by generalizing commands of the target software to test into functions. The software test method includes the step of (a) generating an object file in which keywords, each of which indicates an object of the software, are in an order in which it is desired to test the software. The keywords are sequentially recorded and are distinguished by respective object identifiers. In a step (b), the method sequentially reads keywords recorded in the object file one by one, and calls a function from the function library file for executing an object corresponding to the read keyword. In a step (c), the method reads one or more keywords succeeding the keyword read in the step (b) as a predetermined number of function factors needed for executing the function called in the step (b), and executes the function called in the step (b). In a step (d), the method continues the test by returning to the step (b) if keywords which are not executed exist in the object file. Otherwise, the method ends the test.

To accomplish another aspect of the present invention, a software test method is also provided for testing target software in a software test system which is executed in a computer. The software test system has a function library file obtained by generalizing commands of the target software to test into functions. The software test method includes the step of (a) extracting keywords corresponding to respective objects of the software and factor values for executing functions from a test execution script file. The text execution script file is generated when the target software is executed in a predetermined testing order. The software test method builds an object database by sequentially storing the extracted keywords and factor values in a testing order. In a step (b), the method sequentially reads the keywords and factor values from the object database and calls functions for executing objects corresponding to the read keywords. In a step (c), the method executes the called function using the factor value read in the step (b). In a step (d), the method continues the test by returning to the step (b) if keywords which are not executed exist in the object database. Otherwise, the method ends the test.

To accomplish another aspect of the present invention, a computer readable recording medium is provided which has embodied thereon a software test program for executing a software test method for testing target software in a software test system. The software test system is executed in a computer and has a function library file for functionizing commands of target software generalized into functions. The software test system also has an object file for recording keywords, each of which indicates an object of the target software. The keywords are recorded in an order in which it is desired to test the software. Each of the keywords is distinguished by an object identifier. The software test method includes the step of (a) sequentially reading keywords recorded in the object file one by one and calling from the function library file a function for executing an object corresponding to the read keyword. In a step (b), the method reads one or more keywords succeeding the keyword read in the step (a) as a predetermined number of function factors needed for executing the function called in the step (a) and executes the function called in the step (a). In a step (c), the method continues the test by returning to the step (a) if keywords which are not executed exist in the object file. Otherwise, the method ends the test.

### BRIEF DESCRIPTION OF THE DRAWINGS

The above objects and advantages of the present invention will become more apparent by describing in detail a preferred embodiment thereof with reference to the attached drawings in which:

FIG. 1 illustrates generation of scripts when target software is automatically tested using TeamTest;

FIG. 2 illustrates script files which are generated when target software is executed according to a test scenario in prior art;

FIG. 3 illustrates the concept of a software test system according to the present invention;

FIGS. 4A through 4C illustrate examples of an object file, an execution program, and a function library file, respectively, shown in FIG. 3;

FIG. 5 is a flowchart for explaining an embodiment of a software test method according to the present invention;

FIG. 6 is a block diagram briefly showing another embodiment of the software test system according to the present invention;

FIG. 7 illustrates a screen in which a keyword and a factor value can be edited in an order in which software is tested, according to an object database through a user interface;

FIG. 8 illustrates another embodiment of the software test method according to the present invention;

FIG. 9 is a flowchart for showing a method for automatically building an object database by a script analyzing unit in step 62 of FIG. 8;

FIGS. 10A through 10E are diagrams for showing the process of generating an object database by steps shown in FIG. 9;

FIG. 11 is a bar chart that illustrates the time saved using the software test method according to the present invention.

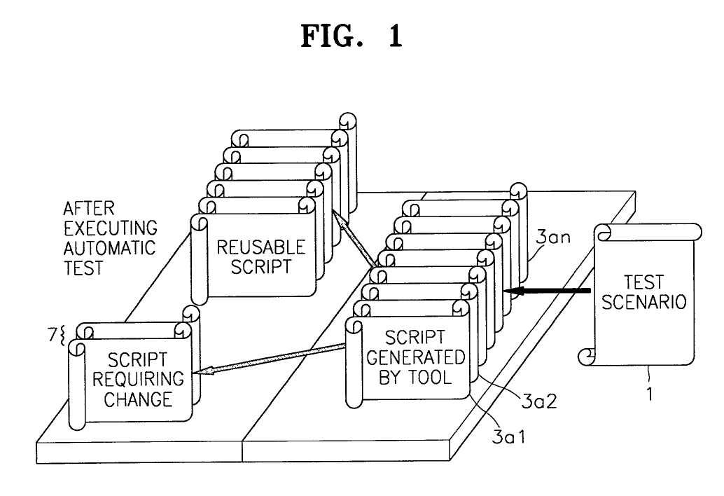

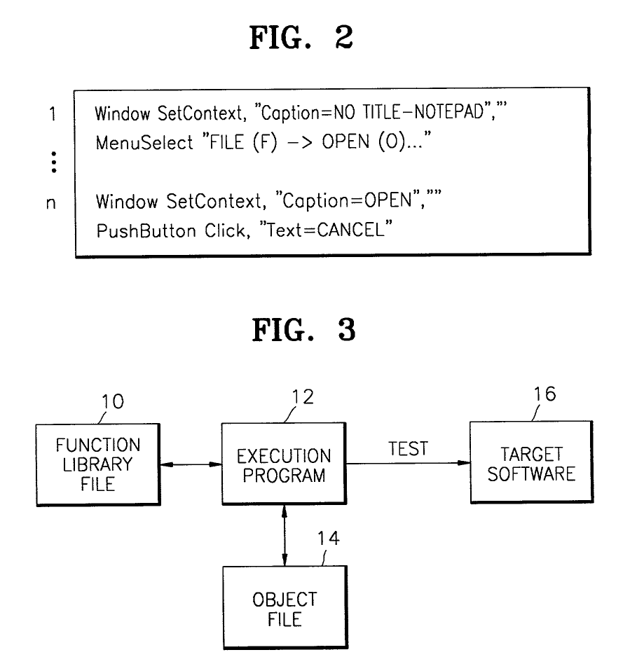

### DETAILED DESCRIPTION OF THE PREFERRED EMBODIMENTS

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to anyone skilled in the art.

FIG. 3 briefly illustrates an embodiment of the software test system according to the present invention. The software test system according to an embodiment of the present invention comprises a function library file 10, an object file 14, and an execution program 12, and, for the convenience of explanation, target software 16 desired to test are shown together in FIG. 3. Here, the target software 16 and the execution program 12 are made of program codes executable in a computer. Also, the execution program can be programmed using programming language SQABasic, which is provided by Rational TeamTest from Rational Software Corporation.

As shown in FIG. 3, commands for executing objects of the target software 16 are generalized into functions and recorded in the function library file 10. In the object file 14, keywords for recognizing objects of the target software 16 are sequentially recorded as keywords in an order in which it is desired to test the target software 16. The execution program 12 recognizes objects desired to execute by sequentially reading keywords from the object file 14, and executes functions by calling functions from the function library file 10 for executing recognized objects. Here, execution of a function means performing a test of the target software 16. The user can observe the executing state of the test through the computer and can get the result of executing the test.

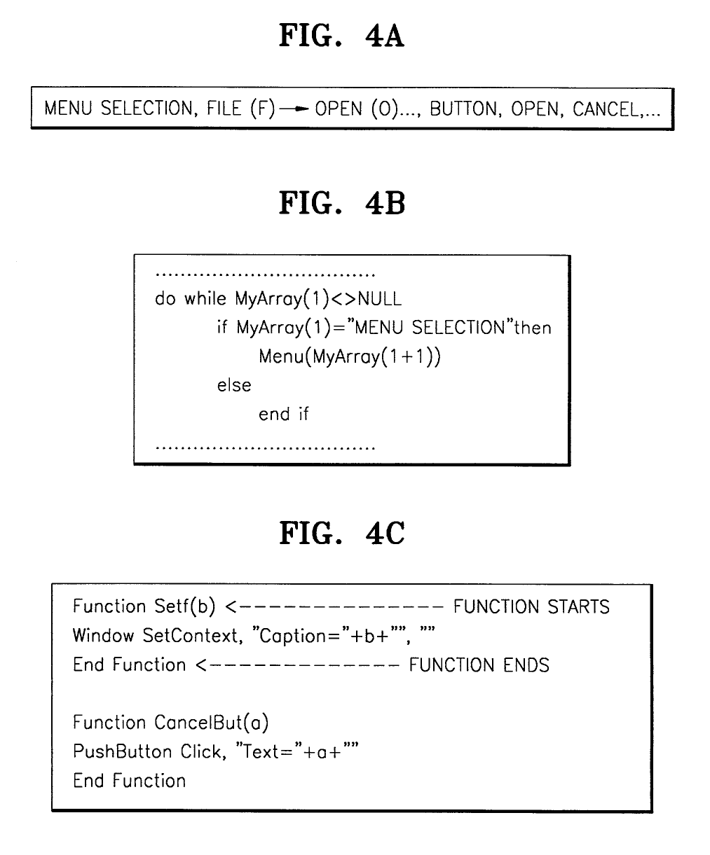

FIGS. 4A through 4C illustrate examples of the object file 14, the execution program 12, and the function library file 10, respectively, shown in FIG. 3. FIG. 4A is an example of the object file 14. Object recognizing values (i.e., keywords), which can recognize the object of the target software, such as “Menu selection,” “File(F)→Open(O)”, “Button”, “Open”, and “Cancel”, are sequentially recorded in this testing order, and each keyword is distinguished by comma “,” which is the object identifier.

FIG. 4B is an example of the execution program 12, which reads a keyword, “Menu selection”, from the object file shown in FIG. 4A, recognizes that a function corresponding to “Menu selection” is “Menu”, calls “Menu” function from the function library file, and executes the function.

FIG. 4C is an example of the function library file, and shows that commands “Window SetContext” and “PushButton Click” are generalized into functions “Setf(b)” and “CancelBut(a)”, respectively.

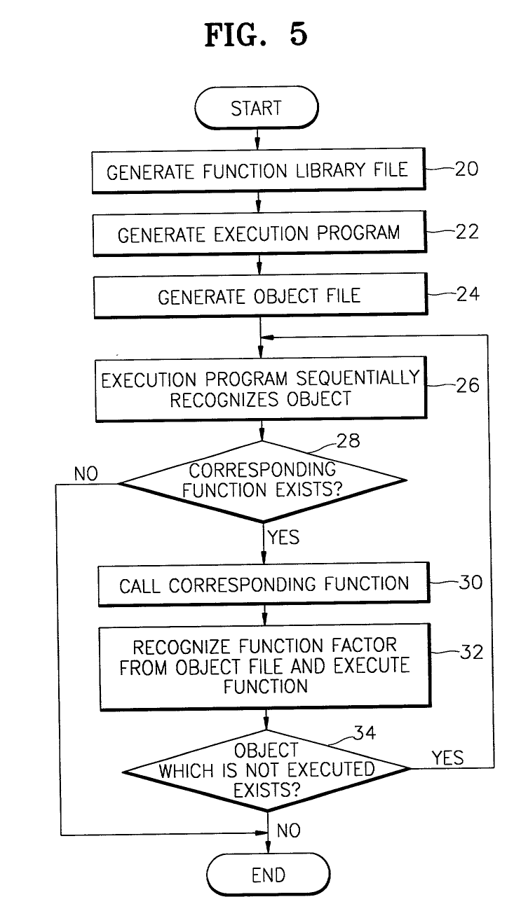

FIG. 5 is a flowchart for explaining an embodiment of a software test method according to the present invention.

As shown in FIGS. 3 through 5, before testing the target software 16 desired to be tested, a plurality of commands for executing the objects of the target software 16 are generalized into functions so that the function library file 10 as shown in FIG. 4C is generated in step 20. After the step 20, the execution program 12 is generated in step 22. An example of the execution program 12 is illustrated in FIG. 4B. The execution program recognizes the object of the target software 16 from a keyword, calls a function from the function library file to execute the recognized object, and performs the test of the target software by executing the called function. After the step 22, the object file 14 is generated in a step 24. An example of the object file 14 is shown in FIG. 4A. In the object file 14, keywords indicating the objects of the target software are sequentially recorded in an order in which it is desired to test the target software.

After the step 24, the execution program 12 recognizes keywords from the object file 14 one by one in step 26. At this time, keywords recorded and distinguished by the object identifier “,” in the object file are recognized. For example, the execution program 12 sequentially reads keywords, such as “Menu selection,” “File(F)→Open(O)”, . . . , “Button”, “Open”, “Cancel”, from the object file 14 shown in FIG. 4A, as distinguished and delimited by the object identifier “,”

At a step 28, the execution program 12 searches the function library file 10 to determine whether or not a function corresponding to the read keyword exists in the library file 10. For example, the execution program 12 reads a keyword, “Menu selection”, and searches the function library file 10 to determine whether or not a function, “Menu”, for executing “Menu selection” is defined in the function library file 10.

If the function corresponding to the keyword read in the step 26 is defined in the function library file 10, the execution program 12 calls the corresponding function in step 30. After reading successive keywords in the step 26 as function factors needed to execute the function, the execution program 12 executes the function in step 32. For example, the execution program 12 reads a keyword, “File(F)→Open(O)”, which follows “Menu selection” in the object file, as a function factor to execute the “Menu” function, and executes the “Menu” function. Here, the execution of the function means performing the test of the target software on a computer, and the result of the execution can be confirmed on the computer.

Meanwhile, in the step 28, if the function corresponding to the keyword read in the step 26 is not defined in the function library file 10, the test is ended.

After the step 32, the execution program 12 determines whether additional keywords not yet executed remain in the object file 14. If any unexecuted keywords remain in the object file 14, the execution program 12 reads the next keywords to continue the test. If no unexecuted keywords remain in the object file 14, the execution program determines that the test is completed, and ends the test in step 34.

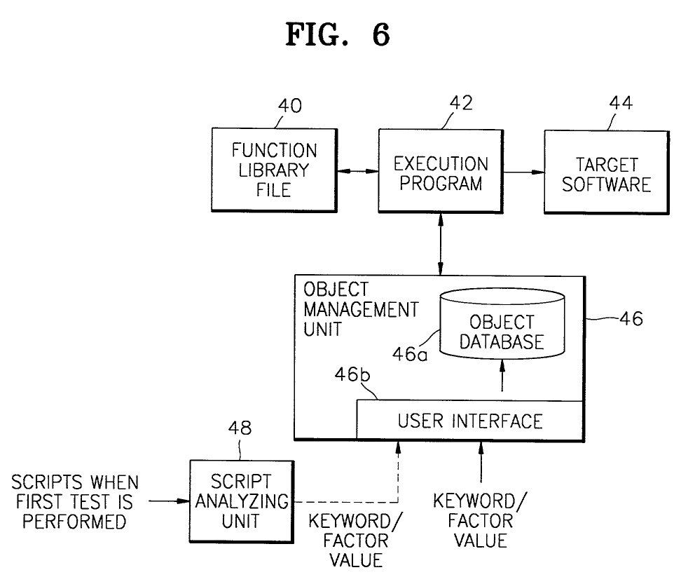

FIG. 6 is a block diagram briefly showing another embodiment of the software test system according to the present invention. The software test system according to the second embodiment of the present invention comprises a function library file 40, an object management unit 46, and an execution program 42. For the convenience of explanation, the target software 44 desired to be tested is shown together with the software test system in FIG. 6. Here, the target software 44 and the execution program 42 are made of program codes executable in a computer. Also, the execution program can be programmed using programming language SQABasic, which is provided by Rational TeamTest from Rational Software Corporation.

As shown in FIG. 6, commands for executing the objects of the target software 44 are generalized into functions and recorded in the function library file 40.

In the object management unit 46, keywords for calling functions to execute objects of the target software 44 and factor values needed to execute functions are sequentially stored in an order in which it is desired to test the target software to form a database. More specifically, the object management unit 46 is formed of a user interface 46B and an object database 46A.

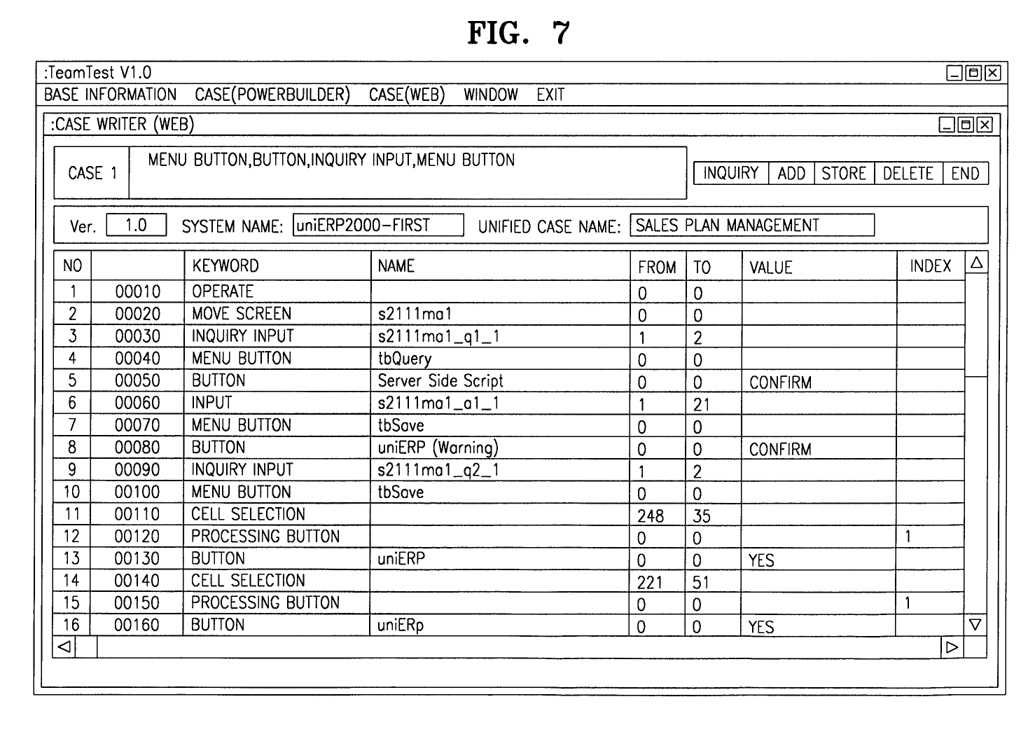

The user interface 46B displays an input window so that keywords and factor values from the outside can be sequentially input in an order in which the target software is tested. That is, a user desiring to test the target software can directly input keywords and factor values through the input window displayed by the user interface 46B in testing order. The user interface 46B will be explained in detail with respect to FIG. 7.

The object database 46A sequentially stores the keywords and factor values input through the user interface 46B. Here, the object database 46A has a table structure, in which the keyword and factor value needed for executing a function are sorted in one row, as shown in the following table 1.

TABLE 1

| | | | |
|---|---|---|---|
| Button | Open | Cancel | |
| Close | Notepad information | | |
| — | — | — | — |
| — | — | — | — |
| — | — | — | — |

For example, “Button” is a keyword for calling a function, and “Open” and “Cancel” are factor values for executing the function called by “Button” keyword. Also, “Close” in the next row is a keyword for calling a function, and “Notepad information” is a factor value for executing the function called by “Close” keyword. Thus, the object database 46A has the table structure in which the keyword for calling a function and the factor values to execute the called function are recorded in one row.

The execution program 42 recognizes an object desired to execute by sequentially reading keywords and factor values in rows, and executes a function by calling the function from the function library file to execute the recognized object. Here, the execution of the function means performing the test of the target software on a computer, and the result of the execution can be confirmed on the computer.

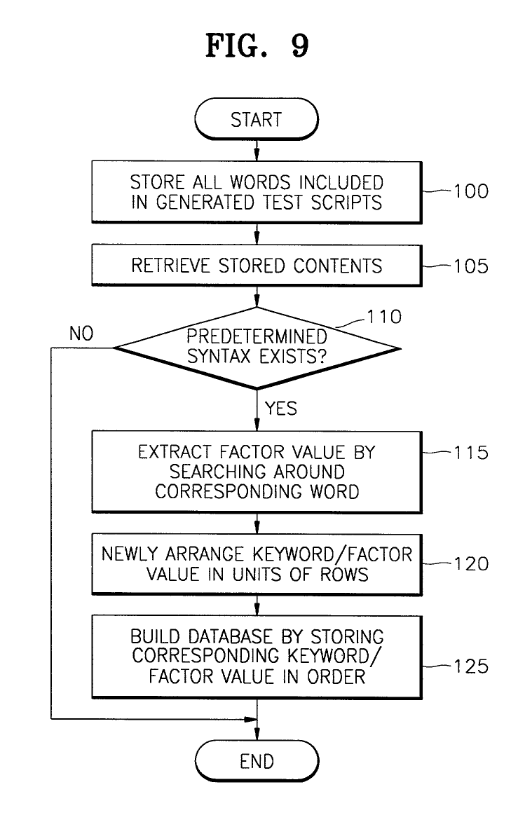

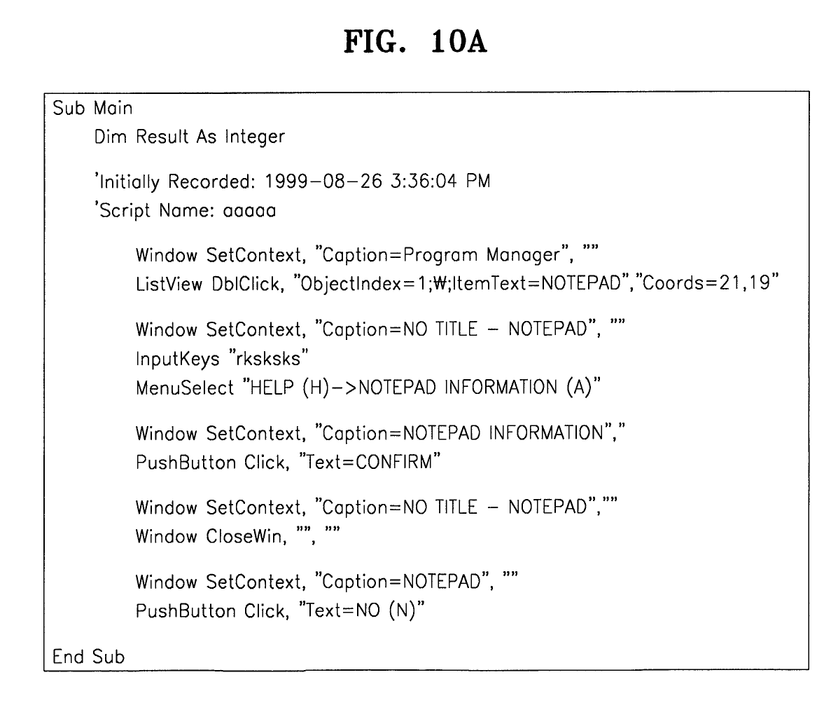

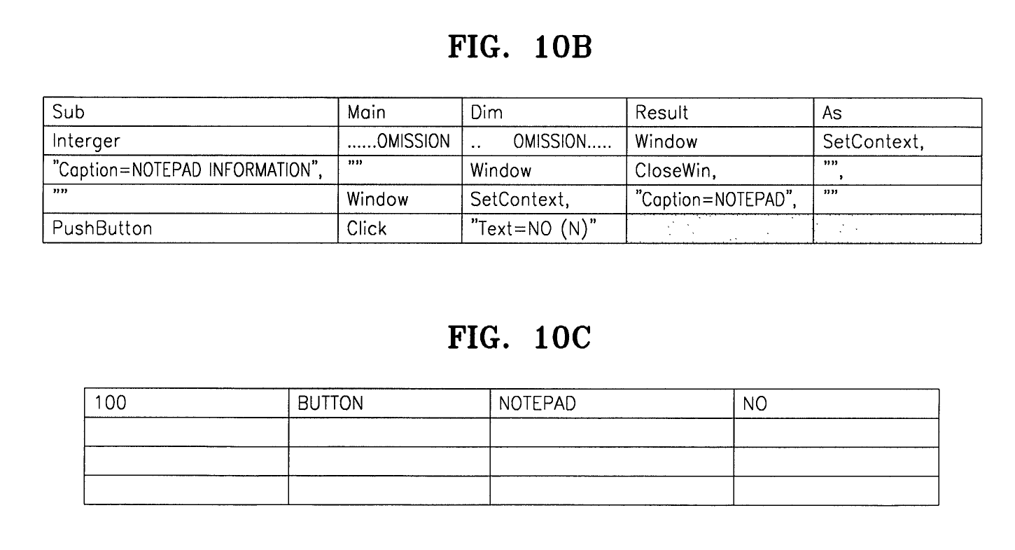

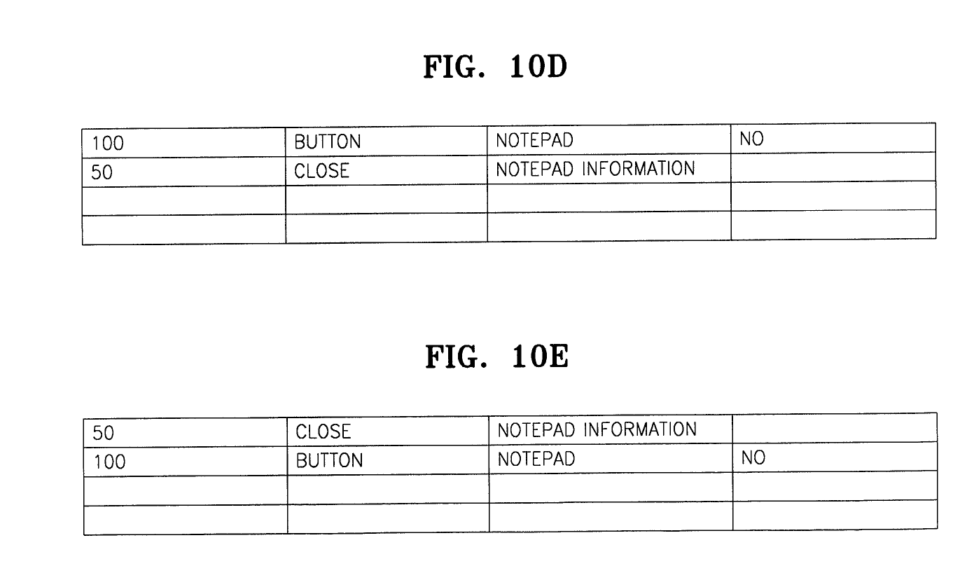

At this time, the object database 46A of the object management unit 46 can be built by a user by directly inputting the keyword and factor values through the user interface 46B. However, as shown in FIG. 6, the keyword and factor values in testing order can automatically be stored in the object database 46A through a script analyzing unit 48. More specifically, the first test is performed in an order in which it is desired to test the target software. Then, as described in the conventional technology, test scripts are generated. The script analyzing unit 48 extracts keywords and factor values in the testing order from the scripts, which are generated when the first test is performed, and stores the extracted keywords and factor values in the object database 46A. The operation of the script analyzing unit 48 will be explained in detail with respect to FIGS. 9 and 10.

FIG. 7 illustrates a screen in which a keyword and a factor value can be edited in testing order through a user interface 46B. The user interface shown in FIG. 7 is used by a user to directly build the object database 46A or to change corresponding keywords when keywords have to change due to changes in the target software program.

As shown in FIG. 7, a user who desires to test a target software program sequentially inputs directly keywords and factor values, such as “Operate”, “Screen movement”, “Inquiry input”, etc., in “keyword” space, through the user interface 46B. Then, the user interface 46B sequentially stores the input keywords and factor values in the object database 46B in the testing order.

Meanwhile, when the script analyzing unit 48 is used as described above, each keyword and factor value in testing order are automatically input and stored in the object database 46A.

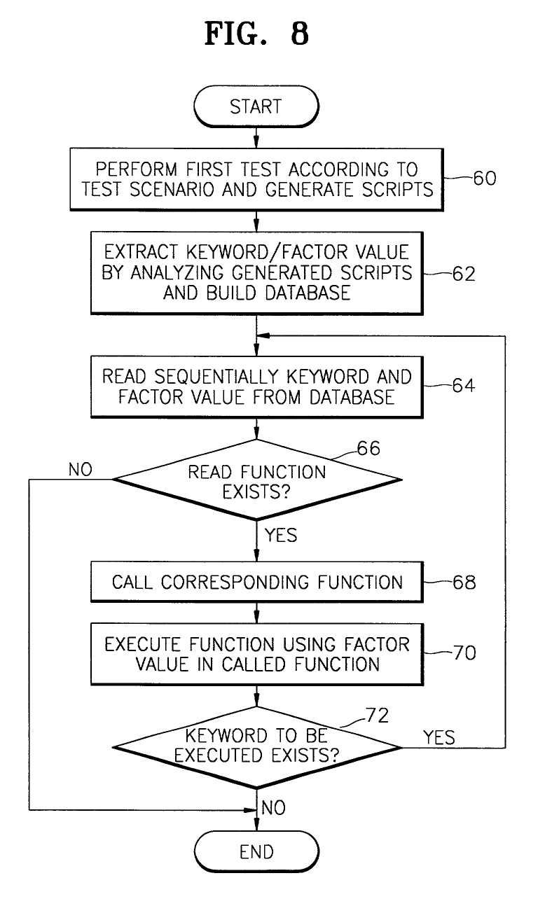

FIG. 8 illustrates another embodiment of the software test method according to the present invention.

As shown in FIGS. 6 and 8, before testing the target software 44 desired to be tested, a plurality of commands for executing objects of the target software 44 are generalized into functions and a function library file 40 (See FIG. 4C) is generated in which the functions are recorded. After the function library file 40 is generated, an object database 46A is generated in step 62 by sequentially recording keywords and factor values. The keywords represent the objects of the target software and are needed to call functions while the factor values are used for executing the called functions. The keywords and factor values are recorded in an order in which it is desired to test the target software. The methods for generating the object database 46A include a manual generation method in which a user desiring to test the target software directly inputs keywords and factor values through the user interface 46A. The method for generating the object data base 46A also includes a method in which the script analyzing unit 48 automatically generates the object database 46A.

If the object database 46A is built in the step 62, the execution program 12 sequentially recognizes keywords and factor values in rows from the object database 46A in step 64. As described above, the execution program 42 reads keywords and factor values, such as “Button,” “Open”, and “Cancel”, in rows from the object database 46A. First, the execution program 42 recognizes a keyword, “Button” and determines whether or not a function corresponding to “Button” exists in the function library file 40 in step 66.

If it is determined that the function corresponding to “Button” exists in the step 66, the function for “Button” is called from the function library file 40 in step 68. The called function is executed by using factor values “Open” and “Cancel” as factors for executing the function in step 70. As described above, here, the execution of the function means performing the test of the target software on a computer, and the result of the execution can be confirmed on the computer.

After the step 70, the execution program 42 determines whether additional keywords not yet executed remain in the object database 46A. If any unexecuted keywords remain in the object database 46A, the execution program 42 reads the next keywords to continue the test. If no unexecuted keywords remain in the object database 46A, the execution program determines that the test is completed, and ends the test in step 72.

FIG. 9 is a flowchart for showing a method for automatically building an object database by a script analyzing unit in step 62.

FIGS. 10A through 10E are diagrams for showing the process of generating an object database by steps shown in FIG. 9.

A method for automatically building an object database will now be explained in detail with reference to FIGS. 6, 9 and 10A through 10E.

To automatically build an object database using the script analyzing unit 48, test-executing scripts are first generated by executing the target software in an order in which it is desired to test the target software. FIG. 10A shows a test-executing script, which is generated as the result of performing a simple test for the notepad.

If such a test-executing script is generated, all words of the test-executing scripts are sequentially sorted and stored, as shown in FIG. 10B, in step 100. At this time, an address for access is assigned to each of arrays storing each words of test-executing scripts.

After the step 100, stored arrays are sequentially retrieved in step 105, and it is determined whether or not a syntax characterizing a predefined function exists in step 110. For example, for the purposes of discussion, it is assumed that function “CancelBut” is defined in the function library file 40 as follows, and a keyword for calling this function is “Button”.

Function CancelBut (a, b)

Window SetContext, “Caption=”+a+“,″″

PushButton Click, “Text=”+b+″″

End Function

To operate and test the above function, function “CancelBut” should be able to be called, and after “″Caption=″” and “″Text=″”, there should be a caption value and a text value as factor values for executing function “CancelBut”, respectively. At this time, referring to the array shown in FIG. 10B, it can be found that needed caption value and text value exist at a predetermined distance in front of and behind the word “PushButton” respectively, and in this case, “PushButton” is used as a syntax word.

The script analyzing unit 48 sequentially retrieves and compares arrays shown in FIG. 10B to determine whether or not the syntax word “PushButton” exist. For example, if the location of “PushButton” is address 100, the location of the caption value is address 98 and the location of the text value is address 102, and the values will be “Notepad” and “No” respectively.

The script analyzing unit 48 newly sorts the address of syntax word, the keyword “Button” for calling function “CancelBut” and factor values “Notepad” and “no” for executing the function, in a row, and stores them as shown in FIG. 10C.

Also, for the purposes of discussion, it is assumed that function “ExitWin” which performs a function for closing a window, is defined as follows, and the keyword for calling this function is “Close”.

Function ExitWin(a)

Window SetContext, “Caption=”+a+″”,

Window CloseWin, “″,″”

To operate and test the above function, function “ExitWin” should be called, and after “″Caption=″”, there should be a caption value as factor value for executing function “ExitWin”. Referring to the array shown in FIG. 10B, it can be found that the needed caption value exists at a predetermined distance in front of the word “CloseWin”.

The script analyzing unit 48 sequentially retrieves and compares arrays shown in FIG. 10B to determine whether or not the word “CloseWin” exist. For example, the location of “CloseWin” is address 50, the location of the caption value is address 47 and the value will be “Notepad information”.

The script analyzing unit 48 newly sorts the address of syntax word “CloseWin”, the keyword “Close” for calling the function “ExitWin” and factor values “Notepad information” for executing the function, in a row, and stores them as shown in FIG. 10D.

As described above, if it is determined in the step 100 that a syntax word characterizing the predefined function exists in the stored array, arrays in front of and behind the word corresponding to the syntax word are searched to extract factor values to execute functions. The arrays are searched in step 115 and are located within a predetermined distance from the word corresponding to the syntax word.

At a step 120, referring to the execution program 42, a keyword for calling the function corresponding to the syntax word is given, and keywords and factor values together with address information of the word corresponding to the syntax are newly sorted in units of row and stored.

Meanwhile, as shown in FIG. 10D, the address of the syntax corresponding to the keyword “Button” is 100, and the address of the syntax corresponding to the keyword “Close” is 50. If the keywords are stored in this order in the object database, the function for “Button” is first executed and then the function for “Close” is executed when the execution program performs the test referring to the object database 46. However, in the original test order, the function for “Close” is first executed and then the function for “Button” is executed. Therefore, as shown in FIG. 10E, the test order is resorted according the address of a syntax and then stored in the object database 46 in step 125.

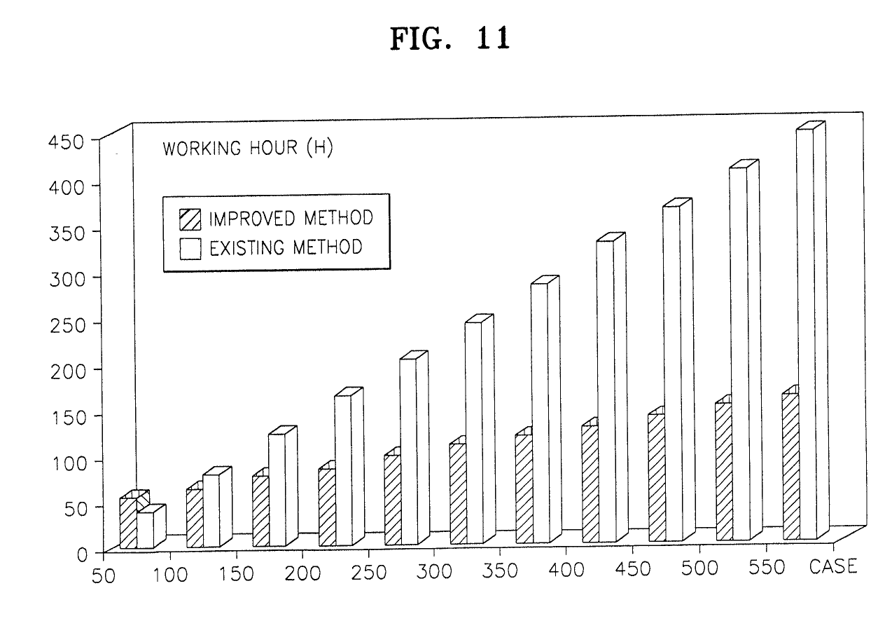

FIG. 11 is a diagram for showing the result of comparison of working time for testing the target software by the software test method according to an embodiment of the present invention to the working time for testing the target software by the conventional software test method.

As shown in FIG. 11, when the number of test items desired to test is small, the conventional software method is advantageous. The reason is the time for building an object database. However, in the conventional method, the more the number of test items is, the more the time for modifying script files due to changes in the target software is needed. Meanwhile, according to an embodiment of the present invention, though the number of test items increases, the time for test does not increase greatly.

Thus, according to the software system and method of the present invention, no time for maintenance for modifying script files due to changes in the target software is needed, because no script files to be managed are used. That is, even though the target software changes, the object files can be used without change unless keywords change. Therefore, although the target software changes, the function library file, the execution program, or the object file need not change, and therefore, maintenance due to changes in target software is not needed.

Also, even though critical changes occur in target software and then keywords change, only modification of the object file in which the keywords are recorded is needed, and the time for the modification is within 0.5 hours.

In conclusion, the maintenance of the test system due to changes in target software can be finished within 0.5 hours. In the conventional technology, many variables, such as the number of scripts, software changing ratio, and the size of a project, affect the maintenance for the software test system. However, in the software test system according to the present invention, maintenance is needed only when critical design changes occur in target software, and even under such circumstances, the maintenance can be finished by only modifying an object file. Also, the software test system and method according to the present invention can be easily applied to other software and product tests, only by re-defining some functions.

The present invention may be embodied in a code, which can be read by a computer, on a computer readable recording medium. The computer readable recording medium may be any kind on which computer readable data are stored. The computer readable recording media may be storage media such as magnetic storage media (e.g., ROM's, floppy disks, hard disks, etc.), optically readable media (e.g., CD-ROMs, DVDs, etc.), or carrier waves (e.g., transmissions over the Internet). Also, the computer readable recording media can be scattered on computer systems connected through a network and can store and execute a computer readable code in a distributed mode.

As described above, in the software test system and method according to the present invention, maintenance due to changes in target software is very simply carried out, and the software test system and method can be easily applied to other software and product tests, only by re-defining some functions.

What is claimed is:

1. A software test system for testing target software which is executed in a computer, the software test system comprising:
a function library file that functionizes and stores commands for executing objects of the target software as functions;
an object file that sequentially records keywords, each of which indicates an object of the target software, in an order in which it is desired to test the target software, each of the keywords distinguished by an object identifier; and
an execution program that sequentially reads keywords from the object file, recognizes an object to execute, calls a function for executing the recognized object from the function library file, and executes the function.

2. A software test method for testing target software in a software test system which is executed in a computer and has a function library file obtained by generalizing commands of the target software into functions, the software test method comprising the steps of:
(a) generating an object file wherein keywords are sequentially recorded in an order in which it is desired to test the target software, each keyword indicating an object of the target software and being distinguished by a respective object identifier;
(b) sequentially reading the keywords recorded in the object file and calling functions from the function library file for executing objects corresponding to the read keywords;
(c) reading one or more successive keywords following each keyword read in the step (b) as a predetermined number of function factors needed for executing each function called in the step (b), and executing each function called in the step (b); and
(d) continuing the test by returning to the step (b) if at least one keyword which is not executed exists in the object file, and otherwise ending the test.

3. A computer readable recording medium having embodied thereon a software test program for executing a software test method for testing target software in a software test system, which software test method is executed in a computer and comprises a function library file for functionizing commands of target software generalized into functions and further comprises an object file for recording keywords in an order in which it is desired to test the target software, each keyword indicating an object of the target software, each keyword distinguished by an object identifier, wherein the software test method comprises the steps of:
(a) sequentially reading keywords recorded in the object file and calling functions for executing objects corresponding to the read keywords from the function library file;
(b) reading one or more successive keywords following each keyword read in the step (a) as a predetermined number of function factors needed to execute each function called in the step (a), and executing each function called in the step (a); and
(c) continuing the test by returning to the step (a) if keywords which are not executed exist in the object file, and otherwise ending the test.

4. A software test system for testing target software which is executed in a computer, the software test system comprising:
a function library file that functionizes and stores commands for executing objects of the target software as functions;
an object management unit for storing keywords corresponding to respective objects of the target software and for storing factor values needed to execute the functions, wherein the keywords and the factor values are sequentially input in an order in which it is desired to test the target software; and
an execution program that sequentially reads the keywords and factor values from the object management unit, that calls the functions corresponding to the factor values to execute the objects corresponding to the keywords, and that executes the called functions using the factor values.

5. The software test system of claim 4, wherein the object management unit comprises:
a user interface for displaying an input window so that the keywords and factors values are sequentially input in a testing order; and
an object database for sequentially storing the keywords and factor values input through the user interface.

6. A software test system for testing target software which is executed in a computer, the software test system comprising:
a function library file that functionizes and stores commands for executing objects of the target software as functions;
a script analyzing unit that extracts keywords and factor values in an order in which the target software is tested from scripts generated when a first test is performed;
an object management unit that stores keywords corresponding to respective objects of the target software and that stores factor values needed for executing the functions, wherein the keywords and the factor values are sequentially input after being extracted by the script analyzing unit; and
an execution program that sequentially reads the keywords and the factor values from the object management unit, calls the functions corresponding to the factor values for executing the objects corresponding to the keywords, and executes the called functions using the factor values.

7. A software test method for testing target software in a software test system which is executed in a computer and which has a function library file obtained by generalizing commands of the target software to test into functions, the software test method comprising the steps of:
(a) extracting keywords corresponding to respective objects of the target software and factor values for executing the functions from a test execution script file, which is generated when the target software is executed in a predetermined testing order, and building an object database by sequentially storing the extracted keywords and factor values in a testing order;
(b) sequentially reading the keywords and factor values from the object database and calling functions corresponding to the factor values for executing objects corresponding to the read keywords;
(c) executing the called function using the factor values read in the step (b); and
(d) continuing the test by returning to the step (b) if at least one keyword which is not executed exists in the object database, and otherwise ending the test.

8. The software test method of claim 7, wherein the step (a) further comprises the sub-steps of:
(a1) generating the test execution script file by executing the target software in an order in which it is desired to test the target software;
(a2) storing the keywords of the generated test execution script file in arrays having a predetermined memory space and providing an address for accessing each of the arrays;
(a3) sequentially searching the arrays to determine whether or not a syntax characterizing a predefined function exists, and if such a syntax does not exist, ending the test;
(a4) if a word corresponding to the syntax in the step (a3) exists, extracting the factor values located within a predetermined distance from the word by searching arrays in front of and behind the word and providing a keyword needed for calling the corresponding function;
(a5) temporarily storing the keyword, factor values, and the address of the word corresponding to the syntax in rows;
(a6) sorting in rows the keywords, factor values, and the address of the syntax stored in the step (a5) according to the address of the syntax; and
(a7) storing the keywords and factor values in rows in the object database in the order as sorted in the step (a5).

9. A computer readable recording medium having embodied thereon a software test program for a method for automatically building an object database in a software test system, which software test program is executed in a computer and comprises a function library file for functionizing commands of target software into functions, the object database storing keywords and factor values in an order in which it is desired to test the target software, wherein the method for automatically building an object database comprises the steps of:
(a1) generating a test execution scripts by executing the target software in an order in which it is desired to test the target software;
(a2) storing words of the generated test execution scripts in arrays having a predetermined memory space, and providing an address for accessing each of the arrays;
(a3) sequentially searching the arrays to determine whether or not a syntax characterizing a predefined function exists, and if such a syntax does not exist, ending the test;
(a4) if a word corresponding to the syntax in the step (a3) exists, extracting the factor values located within a predetermined distance from the word by searching arrays in front of and behind the word, and finding a keyword needed for calling the corresponding function;
(a5) temporarily storing the keywords, factor values, and the address of the word corresponding to the syntax in rows;
(a6) sorting in rows the keywords, factor values, and the address of the syntax stored in rows in the step (a5) according to the address of the syntax; and
(a7) storing the keywords and factor values in rows in the object database in the order as sorted in the step (a6).
